(19) United States
(12) Patent Application Publication
(10) Pub. No.: US 2007/0127179 A1
(43) Pub. Date: Jun. 7, 2007

(54) Burnout protection switch

(76) Inventors: William R. Ludjin, Sto.Nino (PH); Steven R. Reckamp, Hoffman Estates, IL (US)

Correspondence Address: BRINKS HOFER GILSON & LIONE, P.O. BOX 10395, CHICAGO, IL, 60610, US

(21) Appl. No.: 11/294,353

(22) Filed: Dec. 5, 2005

(51) Int. Cl. H02H 9/02

(52) U.S. Cl. 361/93.1

(57) ABSTRACT

A switch connecting a power source and a load may protect its internal circuitry from a current surge. The switch may include a first element, control logic, and a detector. The first element may provide a current path to the load. The detector may detect or measure the voltage across and/or the current flowing through the first element. Based on the measured or detected voltage and/or current, the control logic may remove a control signal provided to the first element, causing the first element to turn off.

### BACKGROUND OF THE INVENTION

1. Technical Field

This invention relates to a switch, and more particularly to a switch that provides protection from current surges.

2. Related Art

Light switches may be equipped with a fault protection circuit. A fault protection circuit may turn off the power to a load when an increase in current is detected. If not controlled, the increase in current may damage the hardware devices and software included within the light switch.

Some light switches equipped with fault protection circuits continue to conduct current for a short period of time even after a fault is detected. If the fault protection circuit is unable to tolerate the current during this short time period, the hardware and/or software included within the switch may still be damaged even though the fault protection circuit has been activated.

### SUMMARY

A switch connecting a power source to a load may protect its internal circuitry from a current surge. The switch may include a first element, control logic, and a detector. The first element may provide a current path to a load. The detector may detect or measure the voltage across and/or a current flowing through the first element. Based on the detected voltage or current, the control logic may remove a control signal provided to the first element, causing the first element to turn off.

Alternatively, a circuit may include a first element, control logic, and a detector. The first element may receive a current flowing through a load. The first element may be controlled by a control signal supplied by the control logic. A detector coupled to the first element may detect a burnout condition across the first element and cause the circuit to break a current path to the load.

Other systems, methods, features and advantages of the invention will be, or will become, apparent to one with skill in the art upon examination of the following figures and detailed description. It is intended that all such additional systems, methods, features and advantages be included within this description, be within the scope of the invention, and be protected by the following claims.

### BRIEF DESCRIPTION OF THE DRAWINGS

The invention can be better understood with reference to the following drawings and description. The components in the figures are not necessarily to scale, emphasis instead being placed upon illustrating the principles of the invention. Moreover, in the figures, like referenced numerals designate corresponding parts throughout the different views.

FIG. 1 is a block diagram of a switching circuit.

FIG. 2 is a block diagram of a switch.

FIG. 3 is a partial schematic of a power switch.

FIG. 4 is a partial schematic of a power supply circuit.

FIG. 5 is a partial schematic of an output circuit.

FIG. 6 is a partial schematic of a detector.

FIG. 7 is an alternative partial schematic of an output drive circuit.

FIG. 8 is an alternative partial schematic of a control logic circuit.

FIG. 9 is a flow diagram of protecting a switch from burnout.

FIG. 10 is a schematic of an exemplary configuration of a switching circuit.

FIG. 11 is a schematic of an alternate configuration of a switching circuit.

### DETAILED DESCRIPTION OF THE PREFERRED EMBODIMENTS

A switch may protect its internal circuitry from a current or voltage overload. The switch may detect the voltage across and/or a current flowing through a switching device. Based on the detected voltage across and/or current flowing through the switching device, the switch may switch off the circuit irrespective of the present phase angle of the power source.

FIG. 1 is a block diagram of a switching circuit 100. The circuit 100 may include a switch 102, such as a light switch; a load 103, such as a light bulb (or a plurality of light bulbs connected in parallel); and a power source 106. Other loads such as a motor or a fan may also be powered. The power source 106 may provide an alternating current to load 103.

In FIG. 1, switch 102 controls a flow of current to load 103. The switch 102 may include a local power switch, such as a toggle switch. While the local power switch is in the on position, current may flow from power source 106 to load 103. When the local power switch is in the off position, switch 102 prevents the flow of current to load 103.

Load 103 may be a light bulb, such as an incandescent bulb, in which a filament gives off light when heated to an intense heat by an electric current. A burnout condition may exist when a measured voltage or current exceeds a determined voltage or current for a determined time period. A light bulb may experience a burnout condition when ionic debris from a failed lamp filament is held in suspension in the electric field between the supporting electrodes of the lamp assembly. This ionic debris forms a plasma arc and effectively creates a short circuit between the lamp electrodes. This short circuit may result in a substantially large flow of current (e.g., burnout current) limited only by the source impedance of the electrical circuit. Additionally, other faults causing a short circuit in series with switch 102, or conditions that may cause a power surge at power source 106 may result in a burnout condition.

Alternate types of local power switches may be used within switch 102 to control the flow of current from power source 106 to load 103. These may include a rocker switch; a mercury switch; or a switch that may vary the flow of current to load 103, such as a dimmer switch. Additionally, the local power switch may be configured to receive a wireless transmission from a remote device 108. The remote device 108 may include a controller to be used as a power switch and/or a dimmer switch to control the amount of current flowing to load 103.

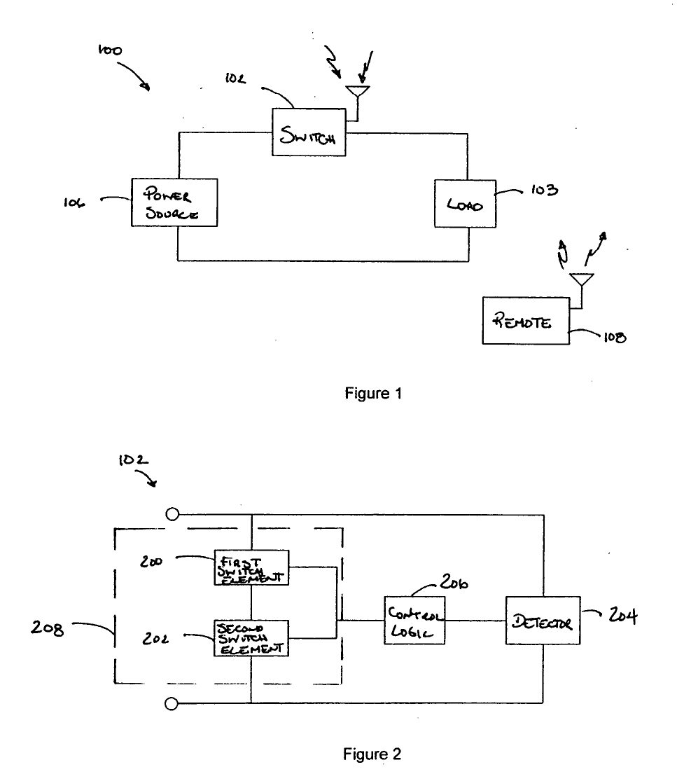

FIG. 2 is a block diagram of switch 102. Switch 102 may include burnout protection logic 208, a detector 204, and control logic 206. Burnout protection logic 208 may include a first switch element 200 and a second switch element 202. In FIG. 2, the first switch element 200 and the second switch element 202 may include an internal and/or external device that substantially allows current to flow in only one direct. The current directing device may be a diode. The first switch element 200 and the second switch element 202 may be configured so that the current directing devices substantially prevent the flow of current through switch 102 when the local or remote power switch is off—indicating that load 103 is off. When the local or remote power switch is on, the first switch element 200 and the second switch element 202 may short circuit an associated current directing device and current may flow through both switching elements. During a first half cycle of the alternating current, current may flow through the switching elements in a first direction. During a second half cycle of the alternating current, current may flow through the switching elements in a second direction, opposite to the first direction.

Control logic 206 may determine when to supply a control signal to the first switching element 200 and the second switching element 202 based on the receipt of a signal from detector 204. When the power switch (e.g., toggle switch, etc.) of switch 102 is turned on, and while detector 204 does not detect a burnout condition, detector 204 directs control logic 206 to provide a control signal to the first 200 and second 202 switch elements. When a burnout condition is detected, detector 204 directs control logic 206 to remove the control signal such that the first switching element 200 and the second switching element 202 stop conducting. At approximately the same time that the control signal is removed, the first switching element 200 and the second switching element 202 break a current path for the circuit. Breaking the current path of the circuit prevents additional current from flowing through switch 102 to load 103.

Detector 204 may be configured to detect a burnout condition. A burnout condition may be detected by analyzing the voltage across and/or current flowing through one or more of the switch elements 200, 202. For exemplary purposes, detector 204 may receive a signal representing a current flowing through the first switching element 200 and the second switching element 202. The product of this current and the internal resistance of one of the first switching element 200 or the second switching element 202 is substantially the voltage across the switching elements. When detector 204 detects a voltage that exceeds a determined threshold for a determined time, detector 204 determines the existence of a burnout condition.

Detector 204 may be programmed to direct control logic 206 to remove the control signal upon the detection of a burnout condition. Additionally, detector 204 may be further configured to wait a determined time before directing control logic 206 to restore the control signal. During the period in which the control signal has been removed, the condition responsible for the burnout condition (e.g., a plasma arc) may dissipate or have been resolved, thereby removing the burnout condition. At the expiration of the determined time, detector 204 directs control logic 206 to restore the control signal. Although the load 103 responsible for the burnout condition is inoperable at this point, additional loads connected in parallel with the load experiencing the burnout condition may still be operative. Restoration of the control signal enables switch 102 to provide current to these additional loads so they may be operated and monitored. If, upon restoration of the control signal, a burnout condition is still present, or a new burnout condition is detected, detector 204 may detect this condition and shut down switch 102. If a burnout condition still exists after a determined number of attempts to restore the control signal, switch 102 shuts down and prevents current from flowing to load 103.

In some switches, a burnout protection circuit may include one switch element, one or more switch elements, or one or more switch elements contained within a unitary device. In burnout protection circuits using one switch element, the switch element may include a plurality of current directing devices. The plurality of current directing devices may be internal and/or external to the switch element. To ensure that the switch element does not permit current to flow when a load is supposed to be off, the plurality of current directing devices may be configured such that the current flow through a current directing device is opposite to the flow of alternating current from a power source. The current directing devices may be diodes.

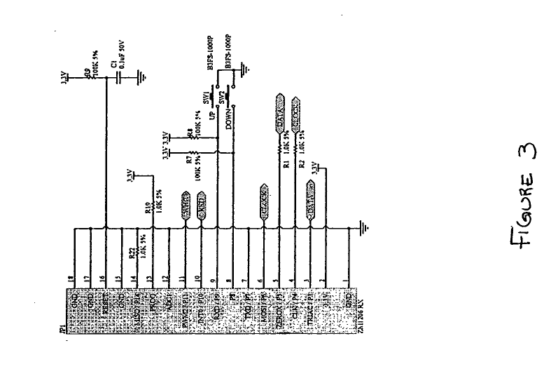

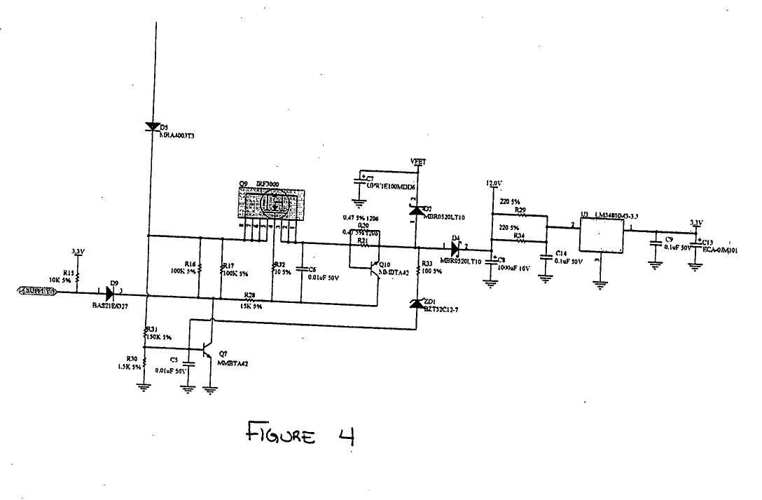

FIG. 3 is a partial schematic of a power switch 300 which may be used with switch 102. Power switch 300 may be a radio transceiver that includes local switches SW1 and SW2, and/or hardware/software that may receive a wireless transmission. Switches SW1 and SW2 and/or the hardware/software that receives a wireless transmission may be used to operate switch 102 causing current to flow from power source 106 to load 103. Power switch 300 may include a processor which may be coupled to a detector or control logic through a data and/or clock signal. The data and/or clock signals may be used by switch 102 to determine how to control the load. The point in time when the switch elements are turned-on may determine the amount of energy supplied to the switch elements which in turn may control the brightness of a light bulb. Alternatively, if power switch 300 includes a dimmer function, the data and clock signals may be used by a processor to generate a timing signal that determines the point during a half-cycle when the switches are to be turned-on. Altering the point when the switches are to be turned-on may control the brightness of an attached load (e.g., a light bulb). A transceiver such as the ZM1206RX may be used for power switch 300.

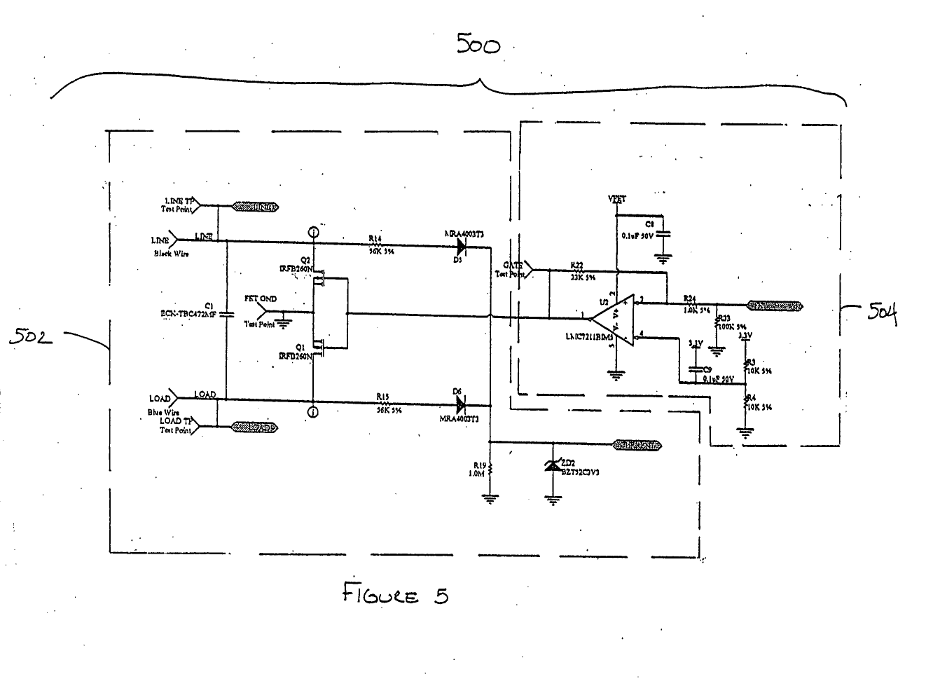

FIG. 4 is a partial schematic of a power supply circuit that may be used with switch 102. Power supply circuit 400 draws a portion of power from power source 106. A small amount of current from the beginning of each half-cycle may be used by power supply circuit 400 to power additional devices within switch 102, such as a microprocessor. This small amount of current is too small to energize load 103. Additionally, power supply circuit 400 may include rectifiers to convert the AC-line voltage into a rectified output. A switching device, such as the IRF3000 Power Metal Oxide Semiconductor Field Effect Transistor (“MOSFET”) by International Rectifier, may use the rectified output to produce a square wave. A phase detector (not shown) may use the square wave as an input to determine the phase of the incoming AC waveform.

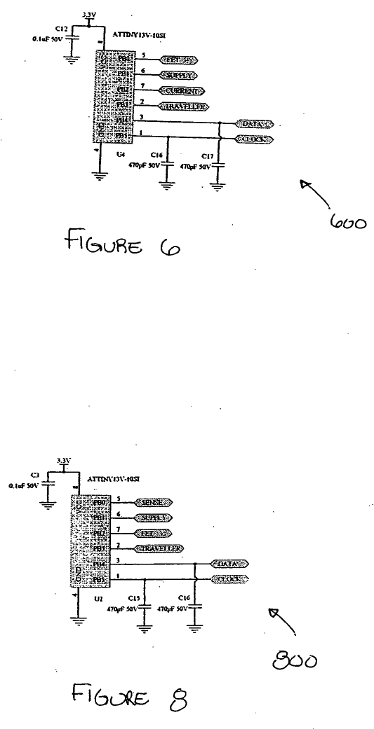

FIG. 5 is a partial schematic of an output drive circuit 500. Output drive circuit 500 may include burnout protection logic 502 and control logic 504. Output drive circuit 500 may be wired in series with a power source 106 and load 103.

Burnout protection logic 502 may include a capacitor C1 and a pair of switch elements Q1 and Q2. Switch elements Q1 and Q2 may be MOSFETs. Capacitor C1 may be used to filter out undesired AC or ripple voltages. If a capacitor is used, it may have a value of about 8800 picofarads. Switch elements Q1 and Q2 provide a current path under the control of control logic 504. Control logic 504 provides a control signal to switch elements Q1 and Q2. Detector 204 controls the generation of the control signal by providing a signal to the non-inverting input of comparator U2 when no bulb burnout condition exists. The control signal biases switch elements Q1 and Q2.

The sources of switch elements Q1 and Q2 connect to circuit ground. The gates of switch elements Q1 and Q2 are coupled together and receive a signal (e.g., control signal) from the output of comparator U2. When the control signal (e.g., a voltage signal) is supplied to the gates of switch elements Q1 and Q2 a carrier-depletion region may be created in switch elements Q1 and Q2. The carrier-depletion region may allow current to flow through switch elements Q1 and Q2. Because both switch elements Q1 and Q2 have their sources coupled to circuit ground and their gates coupled together, when a carrier-depletion region develops across one switch element, a carrier-depletion region may also develop across the other switch element. The existence of the carrier-depletion region may short circuit the current directing devices so current may flow through both switch elements Q1 and Q2 when the control signal is supplied.

Additionally, the drains of switch element Q1 and switch element Q2 couple to detector 204 through a voltage divider. The values of the voltage divider elements may be selected to scale the voltages involved to a suitable level for input to the detector 204. The resistors of the voltage divide may have impedances of about 56 kilo ohms.

Detector 204 measures the voltage and/or current at the drain of the switch elements (Q1, Q2). When detector 204 determines that the voltage across and/or the current flowing through the switch elements exceeds a determined threshold for a determined period of time, detector 204 terminates the signal on the non-inverting input of comparator U2. The termination of this signal terminates the control signal provided to switching elements Q1 and Q2 which causes the switch elements to shut down. When switch elements Q1 and Q2 shut down current is prevented from following to load 103. Comparator U2 may be the LMC7211BIM5 by National Semiconductor, and switching elements Q1 and Q2 may be MOSFETs by International Rectifier.

FIG. 6 is a partial schematic of a detector 600 that may be used with output drive circuit 500. The detector 600 may be a microprocessor, such as the ATTINY13V-10SI by Atmel Corporation. Detector 600 may include a plurality of input and/or output ports. Additionally, detector 600 may include memory, such as programmable flash memory which may be erased and reprogrammed in blocks instead of bytes, electrically erasable programmable read-only memory, or static random access memory; programmable logic; a central processing unit; one or more timers/counters; and/or an analog/digital comparator. A comparator may receive as input the voltage across and/or the current flowing through the switch elements (Q1, Q2) and determine based on the voltage and/or the whether a bulb burnout condition exists.

After detecting a burnout condition, detector 600 may wait for a determined time period before attempting to restore the control signal to switch element Q1 and switch element Q2. This determined time period may be three half-cycles or about 25 milliseconds. If, upon restoration of the control signal, a burnout condition still exits, or a new burnout condition is detected, burnout protection circuit 502, control logic 504, and detector 600 may shut down switch 102. If after a determined number of attempts a burnout condition still exists, detector 600 stops trying to restore the control signal to switch element Q1 and switch element Q2 and switch 102 is shut down.

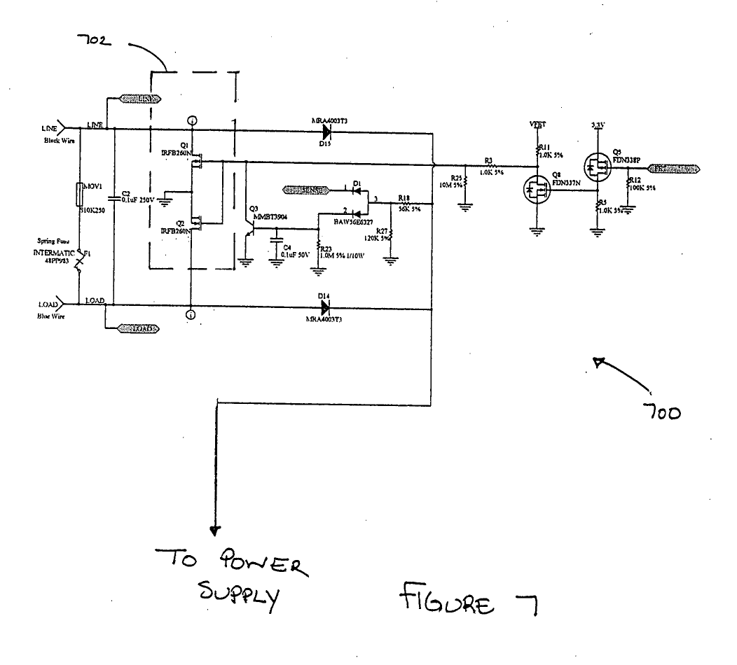

FIG. 7 is an alternative partial schematic of an output drive circuit. Output drive circuit 700 may be coupled to a power source 106, a load 103, power supply circuit 400, and control logic (See FIG. 8). Output drive circuit 700 may include a capacitor C2; burnout protection logic 702, such as a pair of switch elements Q1 and Q2; and a detector. Capacitor C2 may be used to filter out undesired AC or ripple voltages. If a capacitor is used, it may have a value of about 0.01 microfarads. Switch element Q1 and switch element Q2 may be MOSFETs and may provide a current path under the control of control logic 800. Control logic 800 provides a signal to switch element Q5 which together with switch element Q8 provides a control signal to switch elements Q1 and Q2. The control signal provided by switch elements Q5 and Q8 biases switch elements Q1 and Q2.

The sources of switch elements Q1 and Q2 connect to circuit ground. The gates of switch elements Q1 and Q2 are coupled together and receive a signal (e.g., control signal) from the switch element Q5 and switch element Q8. When the control signal (e.g., a voltage signal) is supplied to the gates of switch elements Q1 and Q2 a carrier-depletion region may be created in switch elements Q1 and Q2. The carrier-depletion region may allow current to flow through switch elements Q1 and Q2. Because both switch elements Q1 and Q2 have their sources coupled to circuit ground and their gates coupled together, when a carrier-depletion region develops across one switch element, a carrier-depletion region may also develop across the other switch element. The existence of the carrier-depletion region may short circuit the current directing devices so current may flow through both switch elements Q1 and Q2 when the control signal is supplied.

A third switch element Q3, such as a transistor, and a voltage divider may act as a detector. Switch element Q3 is coupled to the gate of switch element Q1 and switch element Q2. Coupled to the base of Q3 is a voltage divider. The resistors of the voltage divider may have values of about 56 kilo ohms and about 120 kilo ohms. When a load is off, the voltage across switch element Q1 and switch element Q2 may be the full line voltage. The full line voltage may be substantially larger than the voltage during a burnout condition, preventing switch element Q1 and switch element Q2 from being activated. Control logic 800 may monitor the switch to determine when a load is off. While the load is turned off, control logic 800 may ignore the voltage across and/or current flowing through switch element Q1 and switch element Q2 such that the switch elements may be activated when a load is turned on. When no burnout condition exists, no voltage develops across the voltage divider, Q3 remains deactivated, and the switch element Q1 and switch element Q2 provide a current flow to load 103.

When a burnout condition presents itself, the voltage across the voltage divider activates Q3. Activation of Q3 causes the control signal applied to Q1 and Q2 to be taken to ground through Q3; turning off switch element Q1 and switch element Q2. At approximately the same time the control signal is grounded, switch element Q1 and switch element Q2 break a current path, preventing the flow of current to load 103. Control logic 800 senses the state change of Q3 on one of its input ports and, before the next-half cycle begins, terminates the control signal transmitted to switch element Q5.

After detecting a burnout condition, control logic 800 may wait for a determined time period before restoring the control signal to switch elements Q1 and Q2. This determined time period may be three half-cycles or about 25 milliseconds. If, upon restoration of the control signal, a burnout condition is still present, or if a new burnout condition is detected, burnout protection circuit 700 and control logic 800 may shut down switch 102. If after a determined number of attempts the burnout condition still exists, control logic 800 stops trying to restore the control signal to switch element Q1 and switch element Q2 and switch 102 is shut down.

Switch elements Q1 and Q2 may be MOSFETs. Switch element Q3 may be a MMBT3904 switch. Switch element Q5 may be a P-Channel MOSFET, and switch element Q8 may be an N-Channel FET or a HEXFET Power MOSFET.

FIG. 8 is an alternative control logic circuit. Control logic 800 may be a microprocessor. The microprocessor may be the ATTNY13V-10SI by Atmel Corporation. Control logic 800 may contain similar integrated components as microprocessor 600 of FIG. 6; however, the input and output ports of control logic 800 may be connected to burnout protection circuit 700 in a different manner.

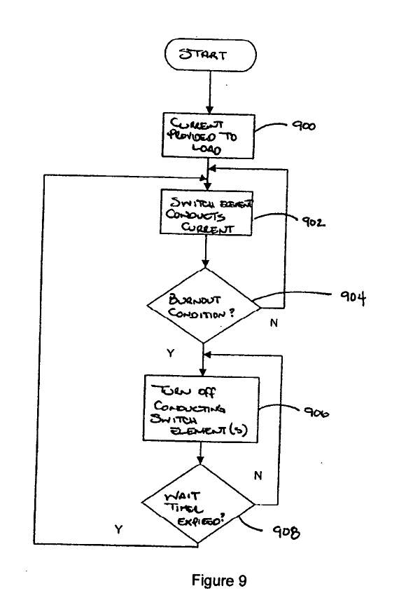

FIG. 9 is a flow diagram for protecting a switch from burnout. At act 900, an exemplary method of operating a switch with a burnout protection circuit commences by supplying an AC signal to a load coupled in series to a switch. When the current is supplied to the switch, a portion may be used by a power supply circuit. The power supply circuit may use the received current to power a device, such as a microprocessor. The microprocessor may be used as a detecting device or as a control logic device. Additionally, the power supply circuit may use the current to generate a waveform representative of the present phase angle of the AC waveform provided to the switch. Once the detector or control logic device has been powered-on, the switch may supply a control signal to one or more protection switch elements. The one or more protection switch elements may be internal and/or external to the switch.

At act 902, the one or more protection switch elements may conduct a current. At act 904, an analysis is performed to see if a burnout condition exists. A burnout condition may be detected by a detector, such as a microprocessor. The detector senses the voltage across and/or the current flowing through the one or more protection switch elements. For exemplary purposes, a detector may determine a voltage across the one or more protection switch elements by measuring and/or estimating a current flowing through a resistor coupled to the one or more protection switch elements and the detector, and the internal resistance of a protection switch element. The detector determines that a burnout condition exists where a determined voltage is detected across the one of the protection switch elements for a determined period of time. The voltage threshold may be about 1.04 V and the time threshold may be about 50 microseconds.

If a burnout condition is detected, the one or more protection switch elements are turned off at act 906. When the detector detects a burnout condition, the control signal supplied to the one or more protection switch elements is terminated. A period of about 5 to 6 microseconds may elapse between the detection of the burnout condition and the removal of the control signal. This time period may permit the switch to account for noise in the circuit that may otherwise appear as a burnout condition.

If a burnout condition does not exist, the one or more protection switch elements continue to provide current to a load. As the polarity of the input signal changes, the direction of current flowing through the protection switch elements may change.

At act 908, a microprocessor may wait for a determined time period before restoring the control signal to the one or more protection switch elements. This time period may be three half-cycles or about 25 milliseconds. The microprocessor tracking the wait period may or may not be the microprocessor used to detect the presence of a burnout condition. After the waiting period has expired, a microprocessor may restore the control signal to the protection switch elements. Upon restoration of the control signal, a current may flow to one or more loads again. Burnout condition monitoring may resume after current begins to flow to one or more of the loads again. If, upon the restoration of the control signal, a burnout condition still exists, or a new burnout condition is detected, the switch may be turned-off and a waiting time/number of burnout conditions may be tracked.

Alternatively, a burnout condition may be determined at act 904 by coupling a separate switch element and voltage divider between the line supplying the one or more protection switch elements' control signal and ground. When a burnout condition presents itself, the voltage across the voltage divider activates the separate switch element. When this separate switch element is activated, it turns-off the one or more protection switch elements by grounding their control signal. Control logic may sense the detection of a burnout condition and disable the one or more protection switch elements; breaking the current path and preventing the flow of current to a load.

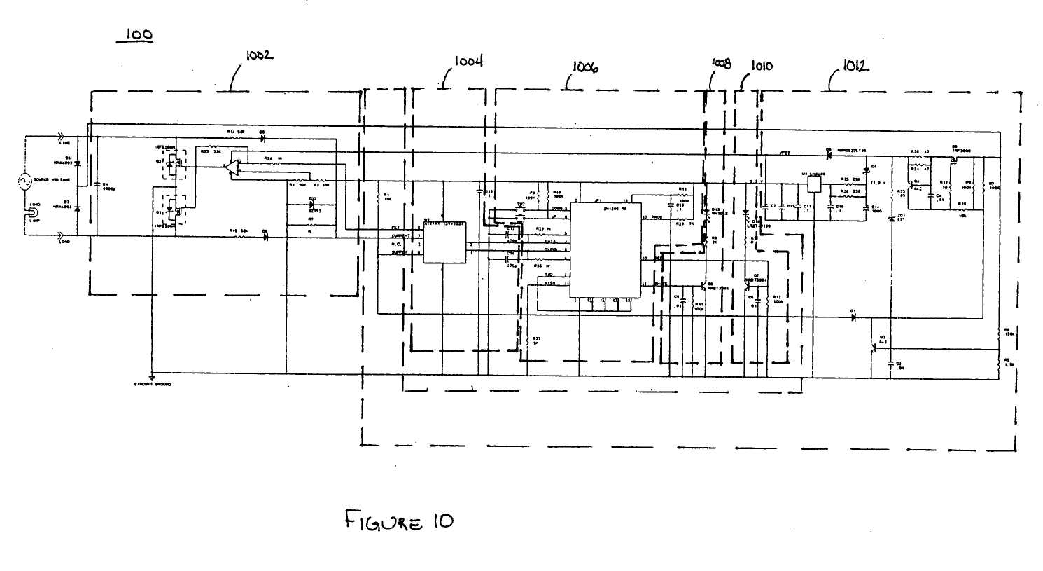

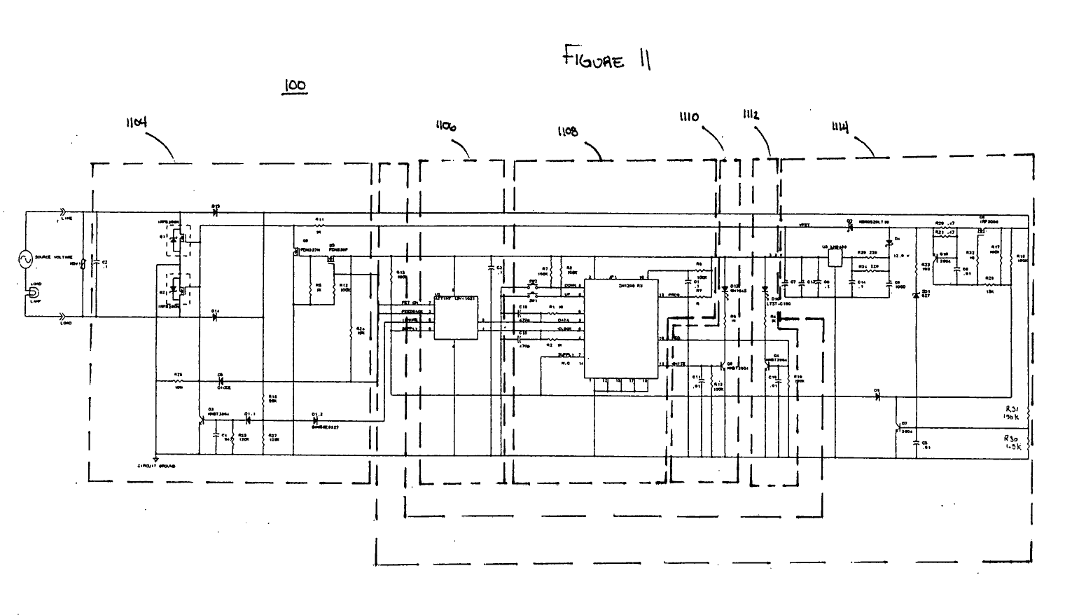

FIG. 10 is a schematic of an exemplary configuration of switching circuit 100. Circuit 1002 may be similar to the circuit 500 in FIG. 5. Detector 1004 may be similar to detector 600 in FIG. 6. Power switch 1006 may be similar to the power switch in FIG. 3. Status circuits 1008 and 1010 include Light Emitting Diodes that may be illuminated under various conditions, such as to relay the operational status of switching circuit 100 to a user. Power supply circuit 1012 may be similar to the power supply circuit in FIG. 4. The switching circuit in FIG. 10 may include the same or more or less components than the components in FIGS. 3, 4, 5, and 6.

FIG. 11 is a schematic of an alternative configuration of switching circuit 100. One difference between FIG. 11 and FIG. 10 is that in the switching circuit in FIG. 11 burnout protection circuit 1104 uses a switch element Q3, and a voltage divider, along with additional components to shut-off switches Q1 and Q2 when a burnout condition is detected. Contrary to this configuration, the switching circuit in FIG. 10 does not use switch element Q3 and a voltage divider to shut-off switches Q1 and Q2 when a burnout condition is detected.

Burnout protection logic 1104 may be similar to the burnout protection logic in FIG. 7. Control logic 1106 controls switching circuit 100 and may be similar to control logic in FIG. 8. Power switch 1108 may be similar to the power switch in FIG. 3. Power switch 1108 may include a local switch which when activated provides power to load 103. Status circuits 1110 and 1112 include Light Emitting Diodes that may be illuminated under various conditions, such as to relay the operational status of switching circuit 100 to a user. Power supply circuit 1114 may be similar to the power supply circuit in FIG. 4. The switching circuit in FIG. 11 may include the same or more or less components that in FIGS. 3, 4, 7, and 8.

While various embodiments of the invention have been described, it will be apparent to those of ordinary skill in the art that many more embodiments and implementations are possible within the scope of the invention. Accordingly, the invention is not to be restricted except in light of the attached claims and their equivalents.

We claim:

1. A switch for connecting a power source to a load, comprising:
a first element configured to connect the power source to the load;
a control logic connected with the first element, where the control logic controls a switching of the first element with a control signal; and
a detector connected with the control logic, where the detector detects at least one of a voltage across or a current flowing through the first element and sends a value to the control logic based on the detected voltage or current, where the control logic controls the first element to break a current path if the voltage across or the current through the first element exceeds a determined amount.

2. The switch of claim 1, further comprising a second element coupled to the first element;
where the detector detects at least one of a voltage across or a current flowing through the first or second elements and sends a value to the control logic based on the detected voltage or current, where the control logic controls the first or second element to break a current path if the voltage across or the current flowing through the first or second element exceeds a determined amount.

3. The switch of claim 2, where the detector is further configured to send a value to the control logic when the detected voltage across or current flowing through the first or second elements exceeds a determined amount for a determined amount of time.

4. The switch of claim 3, where the control logic is configured to remove the control signal after receiving the value from the detector.

5. The switch of claim 4, where the first and second elements break a current path at approximately the same time the control signal is removed.

6. The light switch of claim 5, where the detector is configured to wait a determined period of time after sending the value to the control logic, and then directs the control logic to restore the control signal to the first and second elements.

7. The light switch of claim 6, where the first and second elements are MOSFET devices.

8. A circuit, comprising:
a first element configured to receive a current flowing through a load;
a control logic that controls the first element by supplying a control signal; and
a detector coupled to the first element that detects a burnout condition across the first element;
where the first element breaks a current path once a burnout condition is detected.

9. The circuit of claim 8, further comprising a second element coupled to the first element;
where the detector further detects a burnout condition across the second element and the second element breaks a current path once a burnout condition is detected.

10. The circuit of claim 9, where the first or second element breaks a current path where the detected voltage exceeds a determined amount.

11. The circuit of claim 10, where the first and second elements break a current path at approximately the same time the control signal is removed.

12. The circuit of claim 11, where the detector causes the control logic to suspend the control signal.

13. The circuit of claim 12, where the control logic is configured to restore the control signal after a determined amount of time.

14. The circuit of claim 13, where the first and second elements are MOSFET devices.

15. A method of protecting a circuit from a current surge, comprising:
engaging a first element configured to connect a power source to a load;
detecting a burnout condition across the first element; and
disengaging the first switch once a burnout condition has been detected;
where the first element breaks a current path once it is disengaged.

16. The method of claim 15, further comprising engaging a second element coupled to the first element;
where the second element is engaged when the first element is engaged.

17. The method of claim 16, where the act of engaging the first and second elements comprises supplying the first and second element with a control signal from a control logic.

18. The method of claim 17, where the act of detecting a burnout condition comprises determining that the voltage across the first or second element exceeds a determined amount.

19. The method of claim 18, where the act of detecting a burnout condition comprises determined that the voltage across the first or second element exceeds a determined amount for a determined amount of time.

20. The method of claim 19, where the act of disengaging the first and second elements comprises preventing each of the elements from receiving the control signal.

21. The method of claim 20, further comprising waiting a determined period of time after disengaging the first and second elements before reengaging the first and second elements.
